(19) United States
(12) Patent Application Publication
(10) Pub. No.: US 2014/0313471 A1
(43) Pub. Date: Oct. 23, 2014

(54) Magnetic Applique Eyewear

(71) Applicant: Charles R. Eubanks, St. Petersburg, FL (US)

(72) Inventor: Charles R. Eubanks, St. Petersburg, FL (US)

(21) Appl. No.: 13/867,048

(22) Filed: Apr. 20, 2013

(51) Int. Cl. G02C 11/02

(52) U.S. Cl. CPC G02C 11/02
USPC 351/52; 351/111; 351/121

(57) ABSTRACT

A pair of glasses having one or more double sided appliques sporting decorative embellishments. The appliques are formed from plastic material having the aforementioned decorations thereon. Magnetic material is adhesively applied to the non-decorative side of the appliques thereby facilitating attachment of the aforementioned to the frames and or rims of the pair of glasses. The appliques follow the size and contour of the selected location where it is to be attached on the glasses. Optional depressions on the glasses facilitates the location and attachment of the appliques to the pair of glasses.

### CROSS REFERENCE TO RELATED APPLICATIONS

N/A

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the United States Patent and Trademark Office patent file or records, but otherwise reserves all copyrights whatsoever.

### BACKGROUND

(1) Field of the Invention

Relating to improvements in eyewear worn on the head of an individual.

In America alone, roughly 64% of the population wears some type of eyeglasses. Found in a variety of shapes, sizes, and styles, modern eyewear fundamentally consists of a frame holding a pair of corrective or assistive lenses. Generally these lenses utilize a prescription to help correct conditions such as near or farsightedness, or in the case of sunglasses aid in the protection from sunlight using UV polarizing material or coatings. Of course, these are only the most prevalent examples, as many combinations of lens functions exist. Eyeglass frames consist of a frame front, made up of the eye wire which holds the lenses in place, and the bridge which helps to hold the frame in place on the user's nose. In addition, the frame contains two temples attached on opposite sides of the frame front. These pieces run along the user's head and sit on the ears to further secure the frames to the face.

30 years ago eyewear began to emerge from the realm of strict necessity into the world of fashion, as an accessory and personal statement. In the latter sense, frame color and style has become greatly important to the consumer. Along with advancing trends and personal preferences, consumers constantly desire a variety of style options to coordinate with a certain occasion, mood, or lifestyle. However, this proves to be an expensive and time consuming process as the consumer has to visit the optician or optometrist, purchase a new frame and new lenses, and among other things, undergo measurements and adjustments. Because of these circumstances, there is a need for an option in which the consumer can decoratively embellish the frame with varying colors, patterns, textures, or designs to better suit their current and ever changing desires in a timely and cost effective manner.

### BRIEF SUMMARY OF THE INVENTION

A set of eyewear comprising:

a pair of lenses connected by a connection component

a first temple connected to a first lens

a second temple connected to a second lens and

a depression in the set of eyewear having a magnetically affected material.

In another aspect, wherein the depression is in the first temple.
In another aspect, a magnetically affected material having an image thereon contoured in a shape of the depression in the first temple.
In another aspect, wherein the depression is in the second temple.
In another aspect, a magnetically affected material having an image thereon contoured in a shape of the depression in the second temple.
In another aspect, wherein the depression is in the connection component.
In another aspect, a magnetically affected material having an image thereon contoured in a shape of the depression in the connection component.
In another aspect, a curved attachment connecting the first temple to the first lens.
In another aspect, wherein the depression is in the curved attachment connecting the first temple to the first lens.
In another aspect, a magnetically affected material having an image thereon contoured in a shape of the depression in the curved attachment connecting the first temple to the first lens.
In another aspect, a curved attachment connecting the second temple connected to the second lens.
In another aspect, wherein the depression is in the curved attachment connecting the second temple to the second lens.
In another aspect, a magnetically affected material having an image thereon contoured in a shape of the depression in the curved attachment connecting the second temple to the second lens.
In another aspect, wherein the connection between the first lens and the first temple is through the use of a rim about the first lens.
In another aspect, wherein the connection between the second lens and the second temple is through the use of a rim about the second lens.

An applique for eyewear comprising:

a magnetically affected material shaped in the form of

a depression in the eyewear having

decorative imagery printed thereon.

In another aspect, wherein the decorative imagery is from a set of images comprising: patriotic, religious, family, exotic locales, textures, leathers, colors, vacations, cars, sports, animals, furs, charities, and seasonal events.

A set of eyewear comprising:

a pair of lenses connected by a connection component

a first temple connected to a first lens through

a first rim about the first lens

a second temple connected to a second lens through

a second rim about the second lens and

a depression in the set of eyewear having a magnetically affected material.

In another aspect, wherein the depression is in the first rim with a magnetically affected material therein.
In another aspect, wherein the depression is on a top or side edge of the first rim.
In another aspect, a curved attachment connected between the first temple and the first rim and

a second curved attachment between the second temple and the second rim such that the first and second curved attachments both have a depression having a magnetically affected material therein.

### BRIEF DESCRIPTION OF THE SEVERAL VIEWS OF THE DRAWINGS

FIG. 1 illustrates an embodiment using magnetic applique eyewear having plastic parts with metal inserts using magnetic appliques.

FIG. 2 illustrates an embodiment using magnetic applique eyewear having a full metal rim glasses using magnetic appliques.

FIG. 3 illustrates an embodiment using magnetic applique eyewear having metal rimless glasses using magnetic appliques.

FIG. 4 illustrates an embodiment showing the magnetic appliques that attach through magnetic attraction the outside of a rim, temple or other component of a pair of glasses.

FIG. 5A represents a top view 500 of a plastic temple 510 having an insert 520 to realize the present invention. FIG. 5B represents a top view of another embodiment of the plastic temple 510 having an insert 520 to realize the present invention. FIG. 5c represents a front view of the embodiment of FIG. 5b

FIG. 6 represent one temple 600 connected to an end piece having magnetic material that is to be affixed to the underside of a decorative material 620.

### DETAILED DESCRIPTION OF THE INVENTION

The following detailed description is merely exemplary in nature and is not intended to limit the described embodiments or the application and uses of the described embodiments. As used herein, the word “exemplary” or “illustrative” means “serving as an example, instance, or illustration.” All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in each figure. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

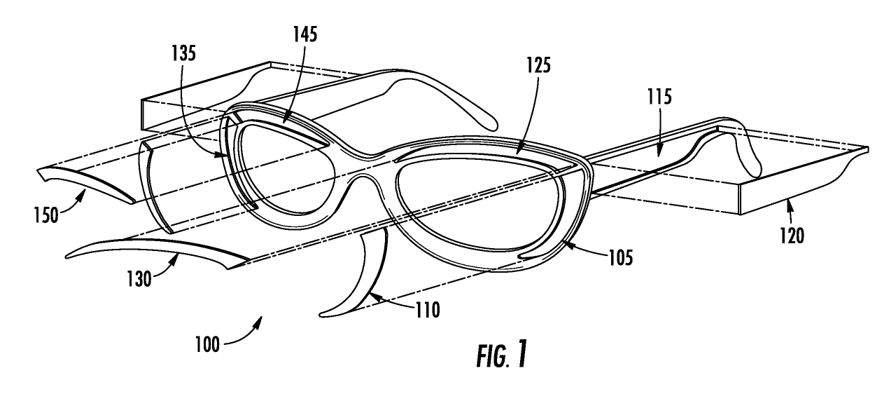

FIG. 1 illustrates an embodiment using magnetic applique eyewear having plastic parts with metal inserts using magnetic appliques. The front of the glasses is usually one solid piece consisting of the eye wire to hold the lenses in place and bridge to connect the eye wire together and rest the entire front on the nose. The two temples are attached usually with hinges to the corresponding font, running from the front of a frame along the user's head and resting on the ears. In FIG. 1, a pair of plastic rimmed glasses 100 is shown having magnetic applique eyewear. The glasses have metal inserts 115 placed within the body of the plastic temple, top 125, 145 and outside rims 105, 135 of the frames; there is another insert in the other temple but this is not shown in the drawing. These metal inserts are to cooperate with magnetic appliques 110, 120, 130, 140, 150 carrying coloring, decorative designs and similar embellishments that are adhesively attached to a refrigerator type piece of magnetic material; of course, there is another one for the other temple not shown in the figure. The magnetic appliques themselves follow the contours of the metal inserts so as to facilitate magnetic attachment to the frame and temples.

In FIG. 1, items 105, 115, 125, 135 and 145 represent exposed metal inserts that are integral with the frame or temple surfaces. When the molding process is underway the design of the mold permits the exposure of the magnetic material surface to the external environment thereby facilitating the magnetic attachment to these exposed zones. As an added positioning alternative the metal inserts are situated in a depression in the plastic rim and or frames so that the magnetic applique can easily be situated thereon by a user. It can be appreciated that each of the metal inserts matches the contours of the temple or rims that it inserted within or attached thereto. For example, the temple insert 115 is described in the drawing as wider near the lenses and tapering on the lower side of the temple that reaches almost to a point as the temple thins out reaching the ear holding end of the temple. Likewise the metal inserts 105 and 125 follow the contours of the rims of the eyewear until they taper to a point. Starting at an approximate top right edge in the drawing the inserts and surface are sized wider then as they proceed further the inserted metal parts taper down the frame 105, 125 and inwards towards the center of the frames respectively. Similarly, the inserts 135 and 145 follow mirror paths as they taper to a point. Finally, the magnetic appliques themselves follow the contours of the metal inserts so as to facilitate magnetic attachment to the frame and temples. Thus, applique 110 follows the contours of insert 105, 120 of 115, 130 of 125, 140 of 135, 145 of 150.

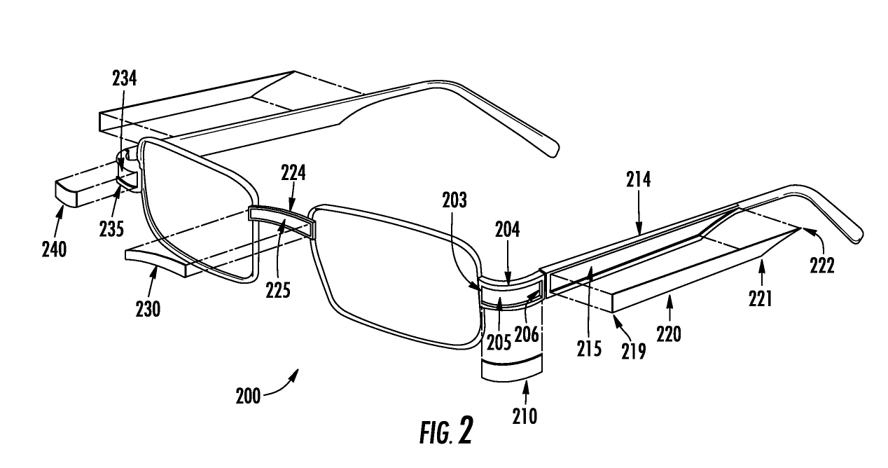

FIG. 2 illustrates an embodiment using magnetic applique eyewear having a full metal rim glasses using magnetic appliques. The eyewire in the figure is a metal piece which surrounds the two lenses and holds them in place. The bridge 224 connects the two eyewires together and sets the frame in place on the user's nose with or without nose pads. An end piece 204 (connection component) is a metal piece, connected to the outer part of the eyewire; end pieces often feature a hinge on which a temple hinge can be attached. Finally the temples are 214 usually attached with hinges on opposite sides of the frame front or opposing end pieces and running along the user's head resting on the ears. A pair of fully rimmed (metal) glasses 200 is shown having magnetic applique eyewear. The glasses have depressions 205, 235 running along the curve of the connection components 204, 234 that is between a temple and the metal rim of the lenses; another contoured depression 215 exists in the temple 214; there is another depression insert in the other temple but this is not shown in the drawing; finally there is a central depression 225 in the central metal connection 224 between the two lens carrying rims. These depressions in the metal surfaces of the temples, connection parts between temples and rims as well as between the rims themselves are to cooperate with a piece of material (typically plastic) or magnetic appliques, 210, 220, 230, 240 that carry coloring, decorative designs and or similar embellishments that are adhesively attached to a refrigerator type piece of magnetic material, coated with magnetic paint, or other magnetic material; of course, there is another one for the other temple not shown in the figure. The magnetic appliques themselves follow the contours of the depressions in the particular region that it is supposed to decorate so as to facilitate magnetic attachment to the frame and temple.

For example, in FIG. 2, depression 205 whilst curved in the middle has two ends that form two vertices 203, 206 of a square on either side of the connection 204; thus, the magnetic applique must follow this general pattern having a curved central region that ends on the right and the left as two right angle vertices or their approximation at either side; the other side of the glasses has another similarly shaped depression-applique pair 234, 235. The applique 220 that follows the contours of depression 215 in the temple 214 starts at a point near the curved connection 204 with to vertices of a square end 219 and proceeds down to a point 222 at its top and to a tapered vertex 221 at the bottom that rapidly tapers to point 222. The other temple has a similar tapered depression and applique that is not shown in the drawing. Similarly, the depression 225 of central metal connection 224 is used to support a magnetic applique 230 that has a size and shape permitting insertion and or attachment of the applique 230 to the depression 225. It is typically an oblong rectangular connector 224 having two vertices of the rectangle on either side.

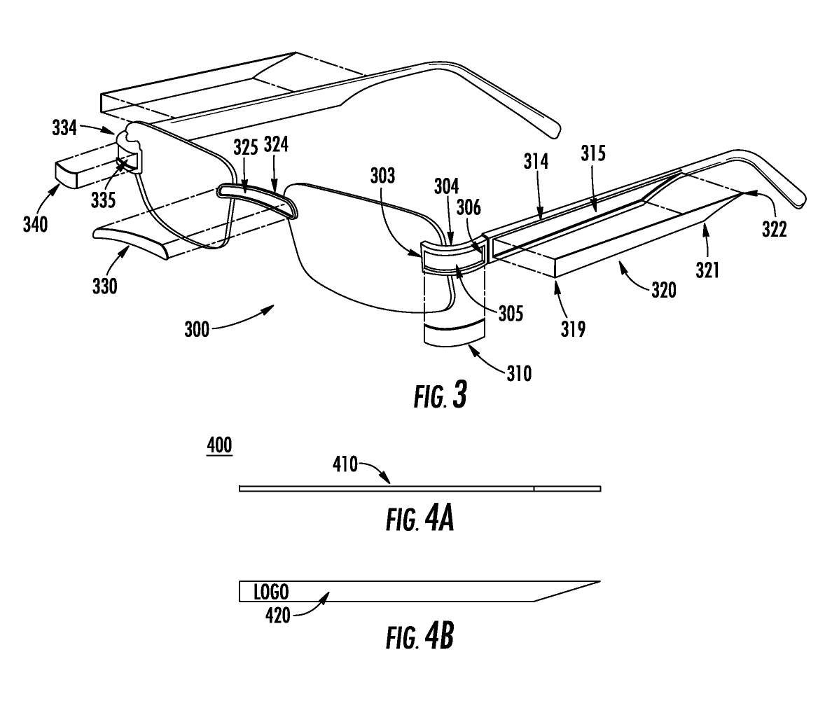

FIG. 3 illustrates an embodiment using magnetic applique eyewear having metal rimless glasses using magnetic appliques. This type of glasses has a bridge 324 (central metal connection) that is the part of the frame front that connects a pair of lenses together and is configured to attach directly to the nasal part of the lens; a bridge, with or without nose pads also sets the frame in place on the user's nose. Next, there is an end piece that is the part of the frame front configured to attach directly to the temporal part of the lens. End pieces 304, 334 (connection components) often feature a hinge on which the temple's hinge can be attached. Finally, there is a temple 314 usually attached with hinges on opposite sides of the frame front or opposing end pieces and running along the user's head resting on the ears. The figure directly shows a pair of rimless (metal) glasses 300 is shown having magnetic applique eyewear. The glasses have depressions 305, 335 running along the curve of the connection components 304, 334 (ends) that is between a temple and the lenses; another contoured depression 315 exists in the temple 314; there is another depression and insert in the other temple but this is not shown in the drawing; finally there is a central depression 325 in the central metal connection 324 (bridge) between the two lenses. These depressions in the metal surfaces of the temples, connection parts between temples and lenses as well as between the lenses themselves are to cooperate with magnetic appliques, (typically a plastic surface attached to some magnetic material) 310, 320, 330, 340 and carrying coloring, decorative designs and similar embellishments that are adhesively attached to a magnetic material; of course, there is another one for the other temple not shown in the figure. The magnetic appliques themselves follow the contours of the depressions in the particular region that it is supposed to decorate so as to facilitate magnetic attachment to the frame and temple.

For example, in FIG. 3, depression 305 whilst curved in the middle has two ends that form two vertices 303, 306 of a square on either side of the connection 304; thus, the magnetic applique must follow this general pattern having a curved central region that ends on the right and the left as two right angle vertices or their approximation at either side. The applique 320 that follows the contours of depression 315 in the temple 314 starts at a point near the curved connection 304 with a two square vertices end 319 and proceeds down to a point 322 at its top and to a tapered vertex 321 at the bottom that rapidly tapers to point 322. The other temple has a similar tapered depression and applique that is not shown in the drawing.

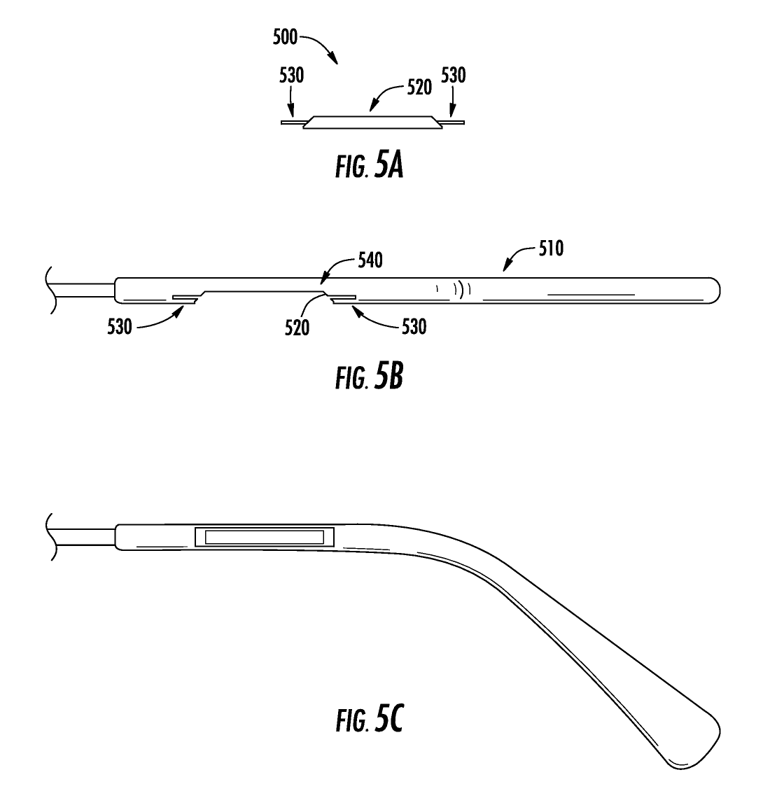

FIG. 4 illustrates an embodiment showing the magnetic appliques that attach through magnetic attraction the outside of a temple or other component of a pair of glasses. FIG. 4a illustrates a top view of a temple applique where the plastic material attached to a magnetic material is indicated as item 410. FIG. 4b illustrates a message 420 for decorating the applique that may also be a coloring, decorative design, picture or similar embellishment; in this instance, the saying 420 from a musical composition Hey Jude! In order to manufacture the appliques the magnetic applique is cut out from a plastic material that has an adhesively applied message material or printing directly on a surface of the material itself. The magnetic material such as refrigerator type magnet, magnetic paint or other magnetic material is attached via adhesives or similar attachment mechanisms. The image thereon reflects the incredible variety that would be wanted in the marketplace: colors, religious, patriotic, seasonal, special events, charities, sports, animals, exotic locations, celebrities, music, art, holographic, exotic wood veneer, rhinestone, leather, fur, textures. A do it yourself kit is envisioned where the inventor can make his or her own appliques from a computer, printer and photoshop type imaging device. Thus, a user will be able to personalize an applique with pictures of family, pets, vacations, cars etc. . . . As a further application of the novelties herein the appliques are useable in the right size and shape with bracelets, bands, shoes, necklaces, earrings and more. FIG. 4c illustrates the magnetic material 420 having an overlay material 430 such as plastic or paper adhesively connected to the magnetic affected material 420; this overlay material 430 has decorations thereon that convey the user's desired effect.

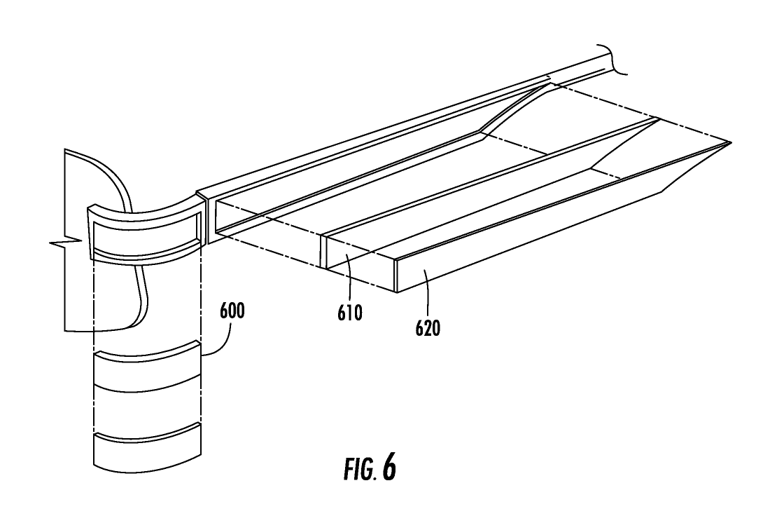

FIG. 5A represents a top view 500 of a plastic temple 510 having an insert 520 to realize the present invention. Here, the insert 520 has two protrusions 530 that jut out longitudinally at either end of the insert 520 and are used to secure the insert 520 within the plastic temple 510 at manufacture. FIG. 5B represents a top view of another embodiment of the plastic temple 510 having an insert 520 to realize the present invention. In this embodiment, the insert 520 has a depression 540 within itself that is used to hold the appliques therein. FIG. 5c represents a front view of the embodiment of FIG. 5b; here, the plastic temple 510 has an insert 520 to realize the present invention. In this embodiment, the insert 520 has a depression 540 within itself that is used to hold the appliques therein. Finally, FIG. 6 represent one temple 600 connected to an end piece having magnetic material that is to be affixed to the underside of a decorative material 620.

Thus, the teaching herein are able to provide a modestly priced eyeglass frame for everyone where its style is easily convertible to any color, texture, image design. Because refrigerator type magnetic materials are ubiquitous, cheap and easy to make it is possible to retail these appliques at a reasonable cost in packs of one or more pieces. Thus, the consumer will believe it is a wonderful value as he or she will be able to change eyewear styles easily and cheaply; further the consumer will be motivated to return to purchase more styles at his prescription changing time because of the low cost and ease of use. Finally, for the purposes of this disclosure, a ‘magnetically affected material’ can be a magnet itself of any variety of materials affected by magnetism such as magnetic paint, ferromagnetic materials etcetera. Additionally, the magnet is relocatable to any part of the rims, temples, eye wire, end pieces, bridges, and or alternatively to the underside of the appliques and or both.

The instant invention has been shown and described herein in what is considered to be the preferred embodiment and alternative embodiments if any. It is recognized, however, that departures may be made therefrom within the scope of the invention. The invention has thus been described in such clear and precise terms as to enable one of ordinary skill in the art to understand its fundamental principles.

I claim:

1. A set of eyewear comprising:
a pair of lenses connected by a connection component
a first temple connected to a first lens
a second temple connected to a second lens and
a depression in the set of eyewear having a magnetically affected material.

2. The set of eyewear of claim 1, wherein the depression is in the first temple.

3. The set of eyewear of claim 2, further comprising:
a magnetically affected material having an image thereon contoured in a shape of the depression in the first temple.

4. The set of eyewear of claim 1, wherein the depression is in the second temple.

5. The set of eyewear of claim 4, further comprising:
a magnetically affected material having an image thereon contoured in a shape of the depression in the second temple.

6. The set of eyewear of claim 1, wherein the depression is in the connection component.

7. The set of eyewear of claim 6, further comprising:
a magnetically affected material having an image thereon contoured in a shape of the depression in the connection component.

8. The set of eyewear of claim 1, further comprising:
a curved attachment connecting the first temple to the first lens.

9. The set of eyewear of claim 8, wherein the depression is in the curved attachment connecting the first temple to the first lens.

10. The set of eyewear of claim 9, further comprising:
a magnetically affected material having an image thereon contoured in a shape of the depression in the curved attachment connecting the first temple to the first lens.

11. The set of eyewear of claim 1, further comprising:
a curved attachment connecting the second temple connected to the second lens.

11. The set of eyewear of claim 10, wherein the depression is in the curved attachment connecting the second temple to the second lens.

12. The set of eyewear of claim 11, further comprising:
a magnetically affected material having an image thereon contoured in a shape of the depression in the curved attachment connecting the second temple to the second lens.

13. The set of eyewear of claim 1, wherein the connection between the first lens and the first temple is through the use of a rim about the first lens.

14. The set of eyewear of claim 1, wherein the connection between the second lens and the second temple is through the use of a rim about the second lens.

15. An applique for eyewear comprising:
a magnetically affected material shaped in the form of
a depression in the eyewear having
decorative imagery printed thereon.

16. The applique of claim 15, wherein the decorative imagery is from a set of images comprising: patriotic, religious, family, exotic locales, textures, leathers, colors, vacations, cars, sports, animals, furs, charities, and seasonal events.

17. A set of eyewear comprising:
a pair of lenses connected by a connection component
a first temple connected to a first lens through
a first rim about the first lens
a second temple connected to a second lens through
a second rim about the second lens and
a depression in the set of eyewear having a magnetically affected material.

18. The set of eyewear of claim 18, wherein the depression is in the first rim with a magnetically affected material therein.

19. The set of eyewear of claim 19, wherein the depression is on a top or side edge of the first rim.

20. The set of eyewear of claim 17, further comprising:
a curved attachment connected between the first temple and the first rim and
a second curved attachment between the second temple and the second rim such that the first and second curved attachments both have a depression having a magnetically affected material therein.
